(19) United States
(12) Patent Application Publication
(10) Pub. No.: US 2006/0235998 A1
(43) Pub. Date: Oct. 19, 2006

(54) Off-loading data formatting to a communicatively coupled client

(75) Inventors: John J. Stecher, Rochester, MN (US); Anthony R. Tuel, Raleigh, NC (US)

Correspondence Address: CAREY, RODRIGUEZ, GREENBERG & PAUL, LLP;STEVEN M. GREENBERG, 1300 CORPORATE CENTER WAY, SUITE 105G, WELLINGTON, FL, 33414, US

(73) Assignee: International Business Machines Corporation, Armonk, NY (US)

(21) Appl. No.: 11/109,306

(22) Filed: Apr. 19, 2005

(51) Int. Cl. G06F 15/16

(52) U.S. Cl. 709/246

(57) ABSTRACT

A method, system and apparatus for offloading the data formatting task to the client-side. A method for off-loading data formatting to a communicatively coupled client can include identifying formatting of raw data in a server-side response to a client-side request for processing. Optionally, the identifying step further can include receiving the server-side response stream from application logic hosted in an application server. The method also can include annotating the raw data in the response stream with a tag indicating a desired format. Finally, the method can include forwarding the response to a client for client-side formatting of the raw data according to the indicated desired format.

### BACKGROUND OF THE INVENTION

1. Statement of the Technical Field

The present invention relates to data processing in an application server and more particularly to formatting data in a view produced through an application server.

2. Description of the Related Art

Prior to the popularization of the Internet and the subsequent implementation of the World Wide Web (“the Web”), software publishers typically distributed computer applications via storage media such as a computer diskette or compact disc. Initially, such stand-alone computer applications included underlying program logic, data storage and, optionally, a user interface. Recently, given the popularization of the Internet and the Web, it is no longer reasonable to presume that computer applications are distributed exclusively via disk medium. Rather, in many cases, conventional computer programs are distributed electronically via the Internet. Specifically, many computer applications are distributed as browser based applications which can include a collection of hypermedia documents such as Web pages which can be viewed in hypermedia content browsers such as Web browsers.

In the case of a browser based application, users can interact with the underlying program logic not through a traditional GUI, but through a GUI provided by GUI elements embedded in a hypermedia document displayed in a content browser. Conventional markup can be visually presented through use of a content browser. Content browsers process display attributes embedded in markup to properly format content also contained within the markup. Notable variants of the content browser include the venerable Web browser, as well as the more recent extensible markup language (XML) browser. Regardless of the type of browser, all conventional markup processors are preconfigured to parse and interpret attribute tags embedded in markup.

While basic browser based applications serve the purpose of simplified computing needs, the content server/content browser arrangement alone cannot support more complex logic. Rather, to handle more complex computing tasks, advanced back-end logic can be integrated with the front end browser based application logic to provide a composite solution. Initially, the back-end logic included conventional programmatic logic configured to be accessed through a gateway medium such as the common gateway interface (CGI). An inability to scale the CGI architecture, however, gave rise more recently to the application server and the cluster of application servers.

In an application server architecture, a content server can be statically linked to an application server or to a cluster of application servers. Complex programmatic logic can reside in the application server. Requests to the content server which require service by one or more application components in the application server can be routed to the application server by way of the static linkage. Notably, the application server can manage the operation of the application components. Moreover, in a clustered arrangement access to the application components can be bolstered by load balancing and failover methodologies. In this way, complex programmatic logic can be accommodated without sacrificing scalability.

Often times, within the application server, raw data can be used for storage or calculation. Before passing the raw data to the presentation interface, the raw data first must be formatted to render the raw data human readable. Traditionally, server-side logic such as a servlet or server page is tasked with the responsibility of formatting raw data by converting the raw data to a string or byte array type format. Subsequently, the server-side logic can insert formatting characters where appropriate depending upon the desired presentation.

For example, to format the float value 1234567.89000 into a currency format, the float can be converted to a char array or byte array, a dollar symbol can be added to the front end of the array, commas can be inserted into the array at three character intervals, a decimal point can be inserted and the last three characters can be dropped. The resulting formatted string can include $1,234,567.89. It will be apparent to the skilled artisan that the formatting process can consume a significant amount of server-side resources. Yet, in an application server, the host computing platform can have limited, taxed resource, while the client computing device hosting the content browser can enjoy substantially untapped resources.

### SUMMARY OF THE INVENTION

The present invention addresses the deficiencies of the art in respect to data formatting in an application server and provides a novel and non-obvious method, system and apparatus for offloading the data formatting task to the client-side. A method for off-loading data formatting to a communicatively coupled client can include identifying raw data in a server-side response to a client-side request for processing. Optionally, the identifying step further can include receiving the server-side response stream from application logic hosted in an application server. The method also can include annotating the raw data in the response stream with a tag indicating a desired format. Finally, the method can include forwarding the response to a client for client-side formatting of the raw data according to the indicated desired format.

In one aspect of the invention, the annotating step can include locating a tag indicating a desired format for the raw data and applying a pair of the tags to the raw data in the response. In another aspect of the invention, the annotating step can include annotating the raw data in the response stream with a tag indicating a desired data conversion and format. Finally, in yet another aspect of the invention, the method can further can include loading a style sheet defining a transformation for the tag in formatting raw data to produce the desired format and providing the transformation to the client for use by the client in performing the client-side formatting.

A system for off-loading data formatting to a communicatively coupled client can include an application server configured with data formatting tag insertion logic. The data formatting tag insertion logic can have programming to identify raw data in a response produced by the application server, to annotate the raw data with a tag indicating a desired format, and to forward the response to a client for client-side formatting of the raw data according to the indicated desired format. For instance, the response can be a hypertext transfer protocol formatted response stream or an Internet inter-object request broker protocol formatted message. The system also can include a style sheet defining a transformation for the tag in formatting raw data to produce the desired format. Finally, a lookup table of tags can be provided which correspond to desired formats for raw data.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a network application distribution system having an application server configured to offload data formatting to a communicatively coupled client; and,

FIG. 2 is a flow chart illustrating a method for offloading data formatting to a communicatively coupled client.

### DETAILED DESCRIPTION OF THE PREFERRED EMBODIMENTS

The present invention is a method, system and apparatus for offloading data formatting to a communicatively coupled client. In accordance with the present invention, a request can be received for processing in the logic layer of a network accessible application and the logic layer can produce raw data as a result. A presentation layer of the network accessible application can identify the raw data and the presentation layer can determine an appropriate formatting for the raw data. Instead of applying the formatting to the raw data, however, the presentation layer can apply one or more formatting tags to the raw data in a response stream to the request to indicate to a communicatively coupled client to apply the appropriate formatting once the client has received the response stream.

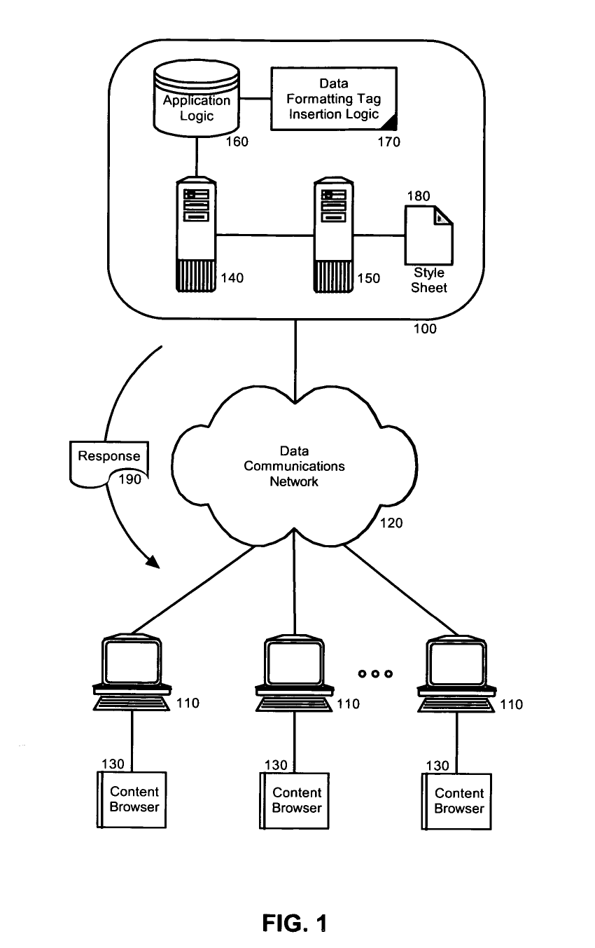

In more particular illustration, FIG. 1 is a schematic illustration of a network application distribution system 100 having a network accessible application configured to offload data formatting to the content browsers 130 of one or more communicatively coupled client 110. The network application distribution system 100 can include a content server 150 configured to process received requests from the content browsers 130 over a data communications network 120, and to provide responses to the requests to the content browsers 130 over the data communications network 120. The content server 150 can be linked to an application server 140 configured to host application logic 150 defining a network accessible application. Importantly, data formatting tag insertion logic 170 further can be coupled to the application server 140.

The data formatting tag insertion logic 170 can include programming to detect raw data produced by the application logic 150 which is to be formatted for presentation in a response 190 to an interacting one of the content browsers 130. Instead of formatting the raw data for inclusion in the response 190, the data formatting tag insertion logic 170 can introduce tags (not shown) into the response 190 in association with the raw data in order to indicate to the interacting one of the content browsers 130 not only that formatting is required for the associated raw data, but also that the associated raw data is to be formatted in a particular way. For example, a pair of the tags can be inserted at either end of the raw data as is known in the field of markup language processing. To that end, the tags (not shown) can include a corresponding instruction in a style sheet 180 in the network application distribution system 100 which can indicate the nature of the formatting indicated by the tags (not shown).

In operation, a request can be received for processing and the request can be processed to produce a response stream for the request. The response stream can be received and it can be determined whether raw data has been included as part of the response stream. If not, the response stream can be forwarded to the client. However, if the response stream is determined to include raw data, the formatting desired for the raw data can be determined. The desired formatting can include, for example, currency formatting, date formatting, scientific notation formatting and time formatting, to name only a few. Once the desired formatting has been determined, suitable tags for the desired formatting can be located, for instance, by referring to a lookup table. The raw data can be associated with the tags within the response stream. Examples include annotating the raw data in the response stream with the located tags. Subsequently, the process can repeat for additional raw data identified in the response stream.

Finally, the response stream containing the tags associated with the raw data can be returned to the client. Upon receipt of the response stream, the content browser of the client can identify the tags for each piece of raw data and the content browser can perform the desired formatting for the raw data based upon the tags. For instance, the content browser can retrieve a transformation from a style sheet in the server to determine how to format the raw data. Alternatively, the content browser can include client-side logic which has been pre-configured to format the raw data according to the associated tags. Examples can include class handlers keyed on the tags, or client-side transformation scripts for the tags.

Notably, the present invention is not limited to the processing of page requests using the hypertext transfer protocol (HTTP). Rather, other approaches can include the Internet inter-object request broker protocol (IIOP) or any other data stream in which raw data can be incorporated into a response stream. Additionally, the invention is not limited to the blind formatting of raw data, but also to the conversion of the raw data from one set of units to another, for instance from one unit of currency or measurement to another.

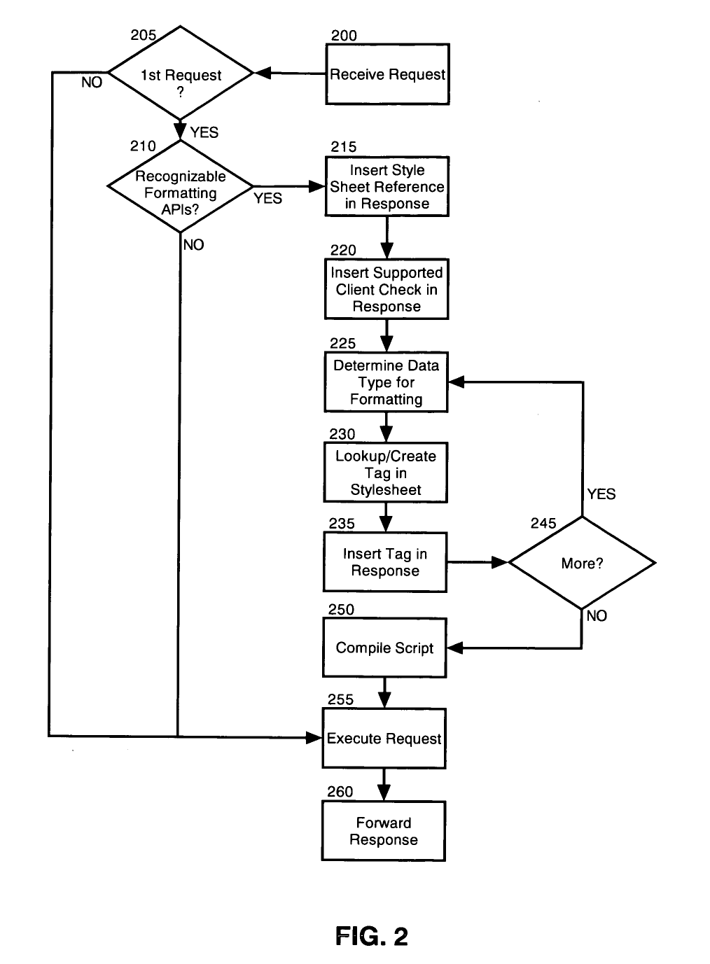

In illustration of a particular aspect of the present invention, FIG. 2 illustrates a process for off-loading data formatting to a communicatively coupled client. Beginning in block 200, a content server can receive a request for processing which can result in the scripted generation of a view to be disposed in a response. In decision block 205, the server can determine if the request is the first request to be processed by the script configured to generate the view. In decision block 210, it can be determined whether recognizable formatting APIs have been included in the script. If there is no use of formatting APIs, the process can continue to block 255 where the request can be executed. Otherwise the process can continue through block 215.

In block 215, a reference can be added to the response to the formatting style sheet. The formatting style sheet can include a script or other means for the processing client to understand how to process embedded formatting tags. Subsequently, in block 220 a check can be inserted in the top of the script to ensure the presence of a supported content browsing client. This check provides a boolean value in the compiled representation of the script as to whether or not the client can execute client side formatting.

In block 225, the data type format can be determined. In block 230, a formatting style sheet can be identified if the desired formatting previously had been utilized. If so, the tag name assigned to the formatting can be determined. Conversely, if no tag is found the tag can be created for the desired formatting and inserted into the formatting style sheet. Subsequently, in block 235, the script can be updated to include the new tag. This can be achieved by inserting a check for a supported client referencing the boolean from block 220. The “if supported client” block of text includes the new tag wrapped about logic to serialize the data to be formatted. In this regard, serialization of data can be done faster than a simple string conversion by dumping the bits of the data into single character bytes. The “if not supported” client block of text includes the original formatting APIs this invention strives to replace. In this regard, both supported clients and non-supported clients can be run simultaneously.

In decision block 245, it can be determined whether additional data remains to be formatted in the script. If so, the process can repeat through block 225. Otherwise, in block 250, the script can be compiled to a native execution language and in block 255 the request can be executed in the course of producing a view as is well known in the art of server side script processing. Subsequently, the response containing the view can be forwarded to the content consuming client in block 260. The client then can receive the response, and the response can be read by the markup language contained within the response. The content browser can recognize the tags and the content browser can consult the style sheet referenced in the response to determine how to display the data contained within the tags.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A method for off-loading data formatting to a communicatively coupled client, the method comprising the steps of:
identifying raw data in a server-side response to a client-side request for processing;
annotating said raw data in said response stream with a tag indicating a desired format; and, forwarding said response to a client for client-side formatting of said raw data according to said indicated desired format.

2. The method of claim 1, wherein said identifying step further comprises the step of receiving said server-side response stream from application logic hosted in an application server.

3. The method of claim 1, wherein said annotating step comprises the steps of:
locating a tag indicating a desired format for said raw data; and, applying a pair of said tags to said raw data in said response.

4. The method of claim 1, wherein said annotating step comprises the step of annotating said raw data in said response stream with a tag indicating a desired data conversion and format.

5. The method of claim 1, wherein said forwarding step comprises the step of forwarding said response to said client using a hypertext transfer protocol formatted response stream.

6. The method of claim 1, wherein said forwarding step comprises the step of forwarding said response to said client using an Internet inter-object request broker protocol formatted message.

7. The method of claim 1, further comprising the steps of:
loading a style sheet defining a transformation for said tag in formatting raw data to produce said desired format; and,
providing said transformation to said client for use by said client in performing said client-side formatting.

8. A system for off-loading data formatting to a communicatively coupled client, the system comprising an application server configured with data formatting tag insertion logic, said data formatting tag insertion logic having programming to identify raw data in a response produced by said application server, to annotate said raw data with a tag indicating a desired format, and to forward said response to a client for client-side formatting of said raw data according to said indicated desired format.

9. The system of claim 8, further comprising a style sheet defining a transformation for said tag in formatting raw data to produce said desired format.

10. The system of claim 8, wherein said response is a hypertext transfer protocol formatted response stream.

11. The system of claim 8, wherein said response is an Internet inter-object request broker protocol formatted message.

12. The system of claim 8, further comprising a lookup table of tags corresponding to desired formats for raw data.

13. A machine readable storage having stored thereon a computer program for off-loading data formatting to a communicatively coupled client, the computer program comprising a routine set of instructions which when executed by a machine causes the machine to perform the steps of:
identifying raw data in a server-side response to a client-side request for processing;
annotating said raw data in said response stream with a tag indicating a desired format; and, forwarding said response to a client for client-side formatting of said raw data according to said indicated desired format.

14. The machine readable storage of claim 13, wherein said identifying step further comprises the step of receiving said server-side response stream from application logic hosted in an application server.

15. The machine readable storage of claim 13, wherein said annotating step comprises the steps of:
locating a tag indicating a desired format for said raw data; and, applying a pair of said tags to said raw data in said response.

16. The machine readable storage of claim 13, wherein said annotating step comprises the step of annotating said raw data in said response stream with a tag indicating a desired data conversion and format.

17. The machine readable storage of claim 13, wherein said forwarding step comprises the step of forwarding said response to said client using a hypertext transfer protocol formatted response stream.

18. The machine readable storage of claim 13, wherein said forwarding step comprises the step of forwarding said response to said client using an Internet inter-object request broker protocol formatted message.

19. The machine readable storage of claim 13, further comprising an additional set of instructions which when executed by the machine causes the machine to further perform the steps of:
loading a style sheet defining a transformation for said tag in formatting raw data to produce said desired format; and,
providing said transformation to said client for use by said client in performing said client-side formatting.
